(19) United States
(12) Patent Application Publication
(10) Pub. No.: US 2026/0203073 A1
(43) Pub. Date: Jul. 16, 2026

(54) RUNNING OF SUB-APPLICATION

(71) Applicant: Tencent Technology (Shenzhen) Company Limited, Shenzhen (CN)

(72) Inventors: Yang LIU, Shenzhen (CN); Runzi SU, Shenzhen (CN); Kunli DENG, Shenzhen (CN); Cong SUN, Shenzhen (CN); Canhui HUANG, Shenzhen (CN)

(73) Assignee: Tencent Technology (Shenzhen) Company Limited, Shenzhen (CN)

(21) Appl. No.: 19/266,156

(22) Filed: Jul. 10, 2025

Related U.S. Application Data
(63) Continuation of application No. PCT/CN2024/079896, filed on Mar. 4, 2024.

(30) Foreign Application Priority Data
May 23, 2023 (CN) 202310594979.9

(51) Int. Cl. G06F 9/445; G06F 8/61

(52) U.S. Cl. CPC G06F 9/445; G06F 8/61

(57) ABSTRACT

In a computer-implemented method for running a child application within a parent application on a terminal, a service page including a child application identifier is displayed via the parent application. In response to a user operation on the child application identifier, a request to run the child application is initiated. In response to the request, a compiled package corresponding to the child application identifier is obtained via a virtual server. The compiled package is parsed to obtain file data associated with the child application. The child application is run in the parent application based on the file data. Apparatus and non-transitory computer-readable storage medium counterpart embodiments are also contemplated.

The present application is a continuation of International Application No. PCT/CN2024/079896, filed on Mar. 4, 2024, which claims priority to Chinese Patent Application No. 202310594979.9, filed on May 23, 2023. The entire disclosures of the prior applications are hereby incorporated by reference.

### FIELD OF THE TECHNOLOGY

This disclosure relates to the field of computer technologies, including a method and an apparatus for running a child application, a computer device, a storage medium, and a computer program product.

### BACKGROUND OF THE DISCLOSURE

With the development of computer technologies, various application programs provide much convenience for users, and working, obtaining information, and shopping online through the application programs become an indispensable part of daily life.

Currently, when the users need to use a child application in a process of browsing a web page, the users usually need to use a mobile terminal to scan a graphic code of the child application, and use the child application in the mobile terminal. This operation is complex and has low efficiency.

### SUMMARY

According to various aspects provided in this disclosure, a method and an apparatus for running a child application, a computer device, a computer-readable storage medium, and a computer program product are provided.

According to an aspect of the disclosure, a computer-implemented method for running a child application within a parent application on a terminal is provided. In the method, a service page including a child application identifier is displayed via the parent application. In response to a user operation on the child application identifier, a request to run the child application is initiated. In response to the request, a compiled package corresponding to the child application identifier is obtained via a virtual server. The compiled package is parsed to obtain file data associated with the child application. The child application is run in the parent application based on the file data.

According to an aspect of the present disclosure, a data processing apparatus is provided. The data processing apparatus includes processing circuitry configured to display, via the parent application, a service page including a child application identifier. The processing circuitry is configured to initiate, in response to a user operation on the child application identifier, a request to run the child application. In response to the request, the processing circuitry is configured to obtain, via a virtual server, a compiled package corresponding to the child application identifier, and parse the compiled package to obtain file data associated with the child application. The processing circuitry is configured to run the child application in the parent application based on the file data.

According to an aspect of the present disclosure, a non-transitory computer-readable storage medium is disclosed. The non-transitory computer-readable storage medium stores instructions which, when executed by at least one processor, cause the processor to perform the computer-implemented method.

According to an aspect of the present disclosure, a method for executing, or running, a child application includes: initiating, when a service page displayed through an application program includes a child application identifier, a child application running request in response to a trigger operation on the child application identifier; when the child application running request is obtained by a virtual server, obtaining a compiled package corresponding to the child application identifier through the virtual server, and parsing the package to obtain file data; and running a child application corresponding to the child application identifier in the application program based on the file data.

According to an aspect, this disclosure further provides an apparatus for running a child application. The apparatus includes: a triggering module, configured to: initiate, when a service page displayed through an application program includes a child application identifier, a child application running request in response to a trigger operation on the child application identifier; a file data obtaining module, configured to: when the child application running request is obtained by a virtual server, obtain a compiled package corresponding to the child application identifier through the virtual server, and parse the package to obtain file data; and a child application running module, configured to run a child application corresponding to the child application identifier in the application program based on the file data.

According to an aspect, this disclosure further provides a computer device, including a memory and one or more processors, the memory having computer-readable instructions stored therein, and the computer-readable instructions, when executed by the processor, causing the one or more processors to perform the following operations: initiating, when a service page displayed through an application program includes a child application identifier, a child application running request in response to a trigger operation on the child application identifier; when the child application running request is obtained by a virtual server, obtaining a compiled package corresponding to the child application identifier through the virtual server, and parsing the package to obtain file data; and running a child application corresponding to the child application identifier in the application program based on the file data.

According to an aspect, this disclosure further provides one or more non-volatile readable storage media, having computer-readable instructions stored therein, the computer-readable instructions, when executed by the processor, implementing the following operations: initiating, when a service page displayed through an application program includes a child application identifier, a child application running request in response to a trigger operation on the child application identifier; when the child application running request is obtained by a virtual server, obtaining a compiled package corresponding to the child application identifier through the virtual server, and parsing the package to obtain file data; and running a child application corresponding to the child application identifier in the application program based on the file data.

According to an aspect, this disclosure further provides a computer program product, including computer-readable instructions, the computer-readable instructions, when executed by a processor, implementing the following operations: initiating, when a service page displayed through an application program includes a child application identifier, a child application running request in response to a trigger operation on the child application identifier; when the child application running request is obtained by a virtual server, obtaining a compiled package corresponding to the child application identifier through the virtual server, and parsing the package to obtain file data; and running a child application corresponding to the child application identifier in the application program based on the file data.

Details of one or more aspects of this disclosure are described in accompanying drawings and descriptions below. Other features, objects, and advantages of this disclosure are apparent from the descriptions, accompanying drawings, and claims.

### BRIEF DESCRIPTION OF THE DRAWINGS

To describe technical solutions in aspects of this disclosure, the following briefly describes accompanying drawings. The accompanying drawings in the following descriptions show merely aspects of examples of this disclosure, and a person of ordinary skill in the art may still derive other drawings from these accompanying drawings.

FIG. 1 is an application environment diagram of a method for running a child application according to an aspect.

FIG. 2a is a schematic diagram of an application scenario of a method for running a child application according to an aspect.

FIG. 2b is a schematic flowchart of a method for running a child application according to an aspect.

FIG. 3 is a schematic diagram of displaying a child application identifier on a service page according to an aspect.

FIG. 4 is a schematic diagram of running a child application on a newly-created page according to an aspect.

FIG. 5 is a schematic diagram of running a child application on a sub-page of a service page according to an aspect.

FIG. 6 is a schematic structural diagram of a child application runtime according to an aspect.

FIG. 7 is a schematic diagram of obtaining file data by a virtual server according to an aspect.

FIG. 8 is a schematic flowchart of running a child application in an application program according to an aspect.

FIG. 9 is a schematic flowchart of transmitting a parent application interface invoking request according to an aspect.

FIG. 10 is a schematic diagram of starting a mini program through a browser according to an aspect.

FIG. 11 is a schematic diagram of a problem detail page of a mini program according to an aspect.

FIG. 12 is a schematic diagram of starting a mini program by scanning a graphic code of the mini program in a browser through a mobile device in the related art.

FIG. 13 is a schematic flowchart of a method for running a child application according to another aspect.

FIG. 14 is a structural block diagram of an apparatus for running a child application according to an aspect.

FIG. 15 is an internal structural diagram of a computer device according to an aspect.

### DETAILED DESCRIPTION

To make objectives, technical solutions, and advantages of this disclosure clearer, this disclosure is further described with reference to the accompanying drawings and aspects. Specific aspects described herein are merely used to explain this disclosure and are not intended to limit this disclosure. Examples of terms involved in the aspects of the disclosure are briefly introduced. The descriptions of the terms are provided as examples only and are not intended to limit the scope of the disclosure.

In this specification and the accompanying drawings, operations and elements that are basically the same or similar are represented by using the same or similar reference signs, and repeated descriptions of these operations and elements are omitted. In addition, in the descriptions of this disclosure, the terms such as “first” and “second” are configured to only distinguish descriptions, and cannot be understood as indicating or implying relative importance or ranking.

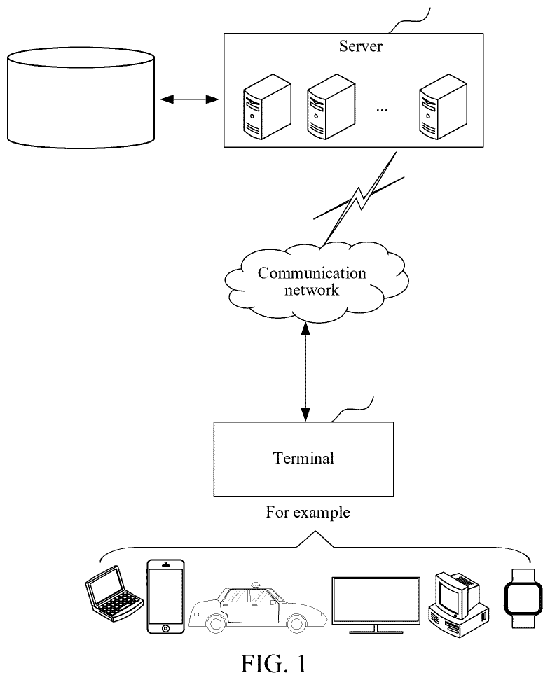

A method for running a child application provided in the aspects of this disclosure may be applied to an application environment shown in FIG. 1. A terminal 102 communicates with a server 104 through a network. A data storage system may store data that the server 104 needs to process. The data storage system may be integrated on the server 104, or placed on a cloud or another network server.

The terminal displays a child application identifier on a service page of an application program. The terminal may initiate a child application running request in response to a trigger operation on the child application identifier. When the child application running request is obtained by a virtual server, the terminal obtains a compiled package corresponding to the child application identifier through the virtual server, and parses the package to obtain file data. The terminal runs a child application corresponding to the child application identifier in the application program based on the file data.

The terminal 102 may be a smartphone, a tablet computer, a notebook computer, a desktop computer, a smart speaker, a smartwatch, an Internet of Things device, or a portable wearable device. The Internet of Things device may be a smart speaker, a smart television, a smart air conditioner, a smart in-vehicle device, or the like. The portable wearable device may be a smart watch, a smart bracelet, a head-mounted device, or the like.

The server 104 may be an independent physical server, or may be a service node in a block chain system. A peer to peer (P2P) network is formed between service nodes in the block chain system. A P2P protocol is an application-layer protocol running over a transmission control protocol (TCP).

In addition, the server 104 may alternatively be a server cluster including a plurality of physical servers, or may be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform.

The terminal 102 may be connected to the server 104 in a communication connection manner such as Bluetooth, a universal serial bus (USB), or a network. This is not limited in this disclosure herein.

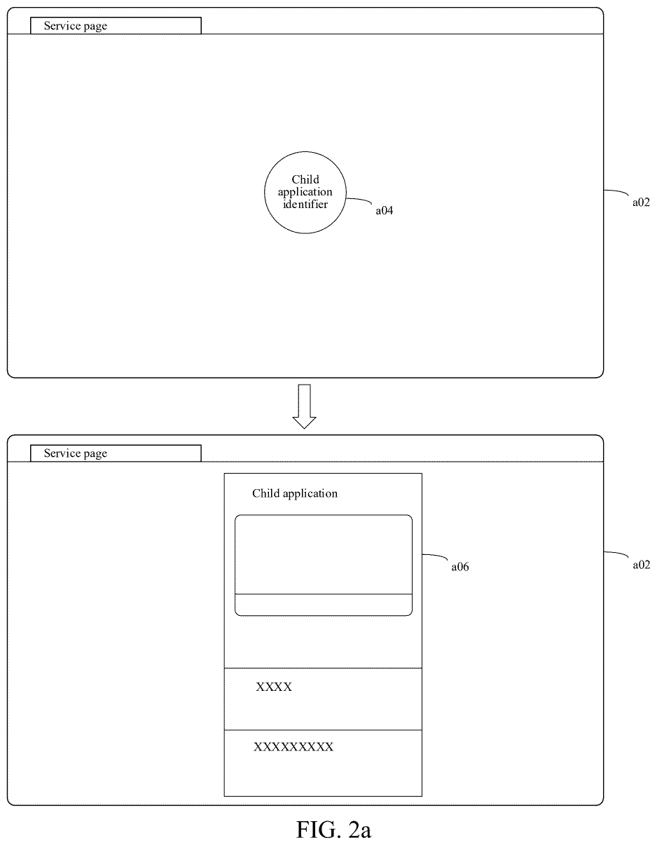

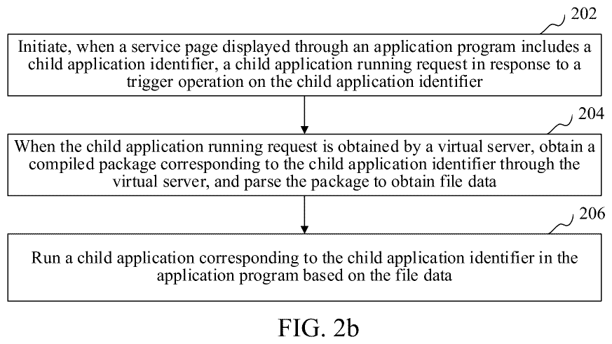

The method for running a child application provided in the aspects of this disclosure may be applied to an application scenario shown in FIG. 2a. A service page a02 is displayed through an application program of a terminal; a child application identifier a04 is displayed on the service page a02; a child application running request is initiated in response to a trigger operation on the child application identifier a04; when the child application running request is obtained by a virtual server, a compiled package corresponding to the child application identifier a04 is obtained through the virtual server, and the package is parsed to obtain file data; and a child application a06 corresponding to the child application identifier is run in the application program based on the file data.

In some aspects, as shown in FIG. 2b, a method for running a child application is provided. An example in which the method is performed by the terminal in FIG. 1 is used for description, and the method includes the following operations.

Operation 202: Initiate, when a service page displayed through an application program includes a child application identifier, a child application running request in response to a trigger operation on the child application identifier. In an example, a service page including a child application identifier is displayed via the parent application. In response to a user operation on the child application identifier, a request to run the child application is initiated.

The application program may be a browser. The page is a page, namely, a web page, displayed in the browser. The service page is a page configured for executing a service, that is, a service may be executed on the service page of the browser. For example, the service page is developed for a service, and the service page may be displayed in the browser through an access address of the service page.

For example, the service may be a service for developing the child application, and a service page configured for developing the child application is displayed through the browser, so that the child application may be developed on the service page displayed in the browser. The service may alternatively be a service for customizing a public account, and a service page configured for customizing the public account is displayed through the browser, so that the public account may be customized on the service page displayed in the browser.

The child application is related to the service executed on the service page. For example, the service executed on the service page includes a plurality of links. The child application may be configured to execute at least one link included in the service. The child application identifier may be an identifier for starting the child application, and may be understood as a form in which an entry of the child application is displayed on the service page, that is, triggering the child application identifier is equivalent to triggering the entry of the child application. The entry of the child application is configured to start the child application, that is, the child application may be run in the application program through the child application identifier displayed on the service page.

In an actual application, the child application may be a mini program, that is, the at least one link in the service executed on the service page may be implemented through the mini program. When the application program is the browser, and the child application is the mini program, in the aspects of this disclosure, the mini program may be run in the browser. Because data needed for running the mini program is small, time consumption of loading the needed data is small when the mini program is run through the browser, so that the mini program can be quickly and conveniently entered.

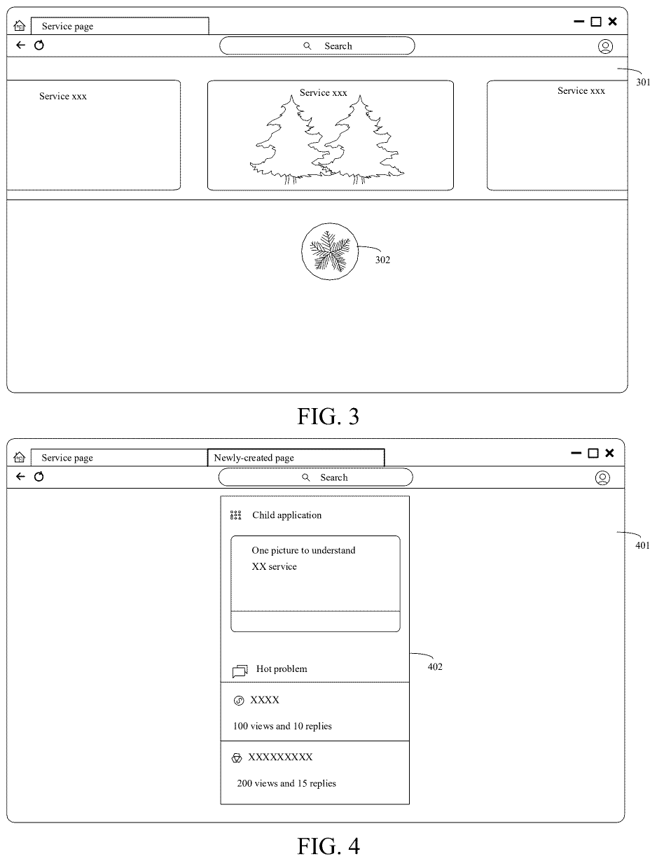

For example, the application program is the browser, and the child application is the mini program. As shown in FIG. 3, the browser is run on the terminal, a service page 301 is displayed in the browser, a corresponding service may be executed through the service page 301, and the service page 301 includes a child application identifier 302 corresponding to the entry of the mini program.

The trigger operation may be a click operation, a touch and hold operation, a slide operation, or certainly another operation configured for indicating selection of the child application identifier. The trigger operation may be performed by a target object on the child application identifier on the service page, the target object may be an object logging in to a service account through the service page, and the service account is an account of the target object on the service page.

For example, the target object logs in to the service account of the target object on the service page. In a process of browsing the service page, the target object performs the click operation, the touch and hold operation, or the slide operation on the child application identifier on the service page, to implement the trigger operation on the child application identifier.

The child application running request is configured for starting the child application, and may be specifically configured for obtaining data needed for starting the child application.

In some aspects, when the application program is run on the terminal, and the service page displayed in the application program includes the child application identifier, the terminal initiates the child application running request in response to that the target object performs the trigger operation on the child application identifier on the service page.

For example, when the application program is the browser, and the child application is the mini program, for the child application identifier displayed on the service page of the browser, the terminal initiates the child application running request in response to the trigger operation performed by the target object on the child application identifier, and the child application running request is configured for starting the mini program in the application program.

Operation 204: When the child application running request is obtained by a virtual server, obtain a compiled package corresponding to the child application identifier through the virtual server, and parse the package to obtain file data. In an example, in response to the request, a compiled package corresponding to the child application identifier is obtained via a virtual server. The compiled package is parsed to obtain file data associated with the child application.

The terminal includes the virtual server, the virtual server is run on a service thread of the application program, the service thread is a regular thread of the application program, and the virtual server may provide a static resource processing service for the application program.

The package obtained by the virtual server is the compiled package needed for starting the child application. Because the virtual server obtains the compiled package, the virtual server may directly use the package to run the child application without compiling a source code of the child application, so that efficiency of running the child application in the application program is high, and a process of wakening the child application through the application program is smoother.

The file data is data obtained by parsing the package, and the file data is also data needed for running the child application. In an actual application, the package is also referred to as a code package, and correspondingly, the file data is data obtained by unpackaging the code package.

In some aspects, the terminal further includes a class library, the class library encapsulates each method for running a child application, and the class library is run on a main thread of the application program. The child application running request is generated through the class library, and the child application running request is transmitted to the virtual server run on the service thread. The virtual server obtains the compiled package of the child application based on the child application running request, and parses the package to obtain the file data.

In some aspects, the child application running request includes an identity number (AppID) of the child application, the identity number is a unique number of the child application, and the child application identifier may be associated with the package through the identity number. After obtaining the child application running request, the virtual server obtains the AppID included in the child application running request, and the virtual server obtains the compiled package corresponding to the AppID.

In some aspects, the application program is a first parent application of the child application, and the child application may alternatively be run in a second parent application. The compiled package of the child application may be a package used for running the child application in the second parent application. To be specific, in the first parent application and the second parent application, the child application may be run through a same package, so that there is no need to additionally develop a package for the first parent application, thereby saving development resources. In addition, the child application used through the first parent application and the child application used through the second parent application have a same human-computer interaction interface and a same use function, so that the child application used through the first parent application can provide same use experience as the child application used through the second parent application.

In some aspects, the second parent application may be an instant communication application. When the application program is the browser, and the child application is the mini program, the virtual server obtains a compiled package of the mini program based on an AppID of the mini program. The package may be a package used for running the mini program in the instant communication application, so that running the mini program in the browser provides same use experience as running the mini program in the instant communication application.

Operation 206: Run a child application corresponding to the child application identifier in the application program based on the file data. In an example, the child application is run in the parent application based on the file data.

In some aspects, after the file data is obtained by parsing the package through the virtual server, the data needed for running the child application is obtained from the file data through the virtual server, and the terminal runs the child application in the application program based on the data needed for running the child application.

In some aspects, the terminal initiates a resource request. The virtual server intercepts the resource request, and returns a corresponding child application entry file based on the resource request. The terminal executes the child application entry file. In a process of executing the child application entry file, the terminal obtains, based on the child application entry file, the data needed for running the child application from the file data obtained by the virtual server. The terminal runs the child application in the application program based on the data needed for running the child application.

In some aspects, the application program is the browser, the service page is a page displayed in the browser, and the terminal displays a newly-created page in the browser in response to the trigger operation on the child application identifier displayed on the service page, and initiates the child application running request. When the child application running request is obtained by the virtual server, the compiled package corresponding to the child application identifier is obtained through the virtual server, and after the package is parsed to obtain the file data, the child application is run based on the file data on the newly-created page of the browser. In other words, wakening the child application through the browser may be displaying the running child application on the newly-created page of the browser.

For example, the child application is the mini program. Referring to FIG. 3 and FIG. 4, the service page 301 is displayed in the browser. In response to the trigger operation on the child application identifier 302 on the service page 301, a newly-created page 401 is displayed in the browser, to facilitate subsequent displaying of a running mini program on the newly-created page 401. When the browser completes starting of the mini program, a main page 402 of the mini program is displayed on the newly-created page 401.

In some aspects, in response to the trigger operation on the child application identifier displayed on the service page, the terminal displays a sub-page on the service page, initiates the child application running request, and after obtaining the file data through the virtual server, runs the child application on the sub-page of the service page based on the file data. In other words, wakening the child application through the browser may be displaying the running child application on the sub-page of the service page.

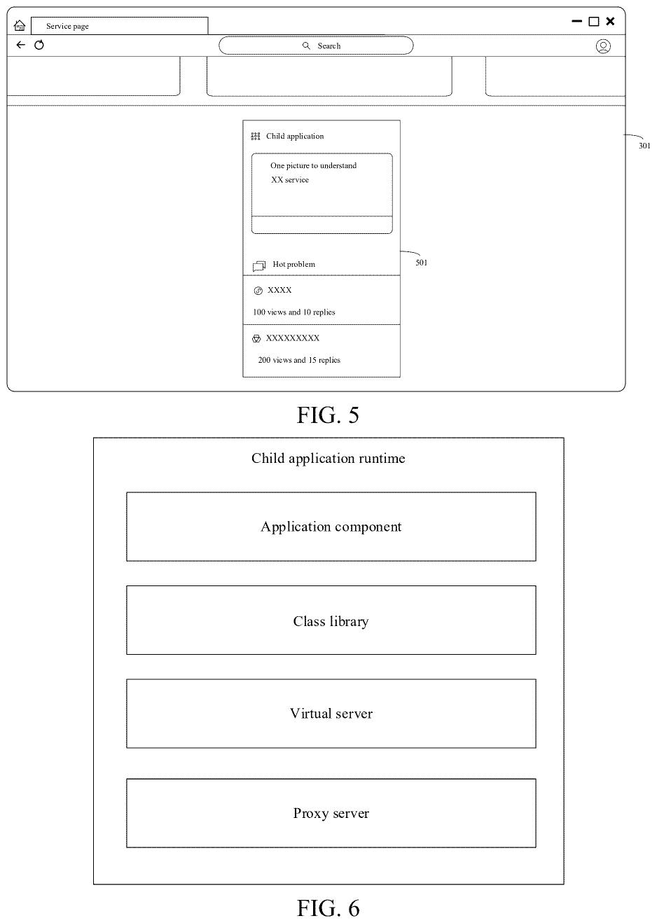

For example, the child application is the mini program. Referring to FIG. 3 and FIG. 5, the service page 301 is displayed in the browser. In response to the trigger operation on the child application identifier 302 on the service page 301, a sub-page 501 is displayed on the service page 301, to facilitate subsequent displaying of a running mini program on the sub-page 501. The sub-page 501 is a main page of the mini program.

In the foregoing method for running a child application, when the service page displayed through the application program includes the child application identifier, in response to the trigger operation on the child application identifier, the child application running request is initiated. When the child application running request is obtained by the virtual server, the compiled package corresponding to the child application identifier is obtained through the virtual server, the package is parsed to obtain the file data, and the child application is run in the application program through the file data. In other words, the child application may be directly run in the application program by triggering the child application identifier on the service page of the application program. Compared with a solution in the related art in which a mobile device scans a graphic code of the child application displayed in the application program and the child application is run in the mobile device, the child application is directly run in the application program, which greatly reduces operation complexity of running the child application and improves efficiency of running the child application. In addition, because the virtual server obtains the compiled package, the virtual server may directly parse the package, and run, through the file data obtained through parsing, the child application without executing a compiling process, so that efficiency of running the child application in the application program is high, and a process of wakening the child application through the application program is smoother.

In some aspects, the initiating a child application running request in response to a trigger operation on the child application identifier includes: initiating a class library interface invoking request through an application component of the application program in response to the trigger operation on the child application identifier, the class library interface invoking request being configured for indicating a class library to initiate the child application running request to the virtual server.

The application component is a component on the service page, that is, the service page may be a complete page obtained by packaging a plurality of components. The application component may be a component in which an entry of the child application is encapsulated, and the child application identifier may be understood as a visual form of the application component.

In an actual application, the application component may be a component implemented based on Vue, or may be a component implemented based on React. Vue and React are both user interface frameworks of JavaScript (a programming language), and may be configured for developing components. In this way, the method for running a child application may conveniently access a page implemented based on Vue and React.

The class library encapsulates each method for running a child application, is run at a main line layer of the application program, and may be configured to initiate the child application running request. The class library interface invoking request is a request for invoking a class library interface.

In some aspects, the trigger operation on the child application identifier may be understood as the trigger operation on the application component corresponding to the child application identifier. When the application component corresponding to the child application identifier receives the trigger operation, the class library interface invoking request is initiated through the application component. The class library interface invoking request is configured for invoking the class library interface, to achieve an access to the class library. When receiving the class library interface invoking request initiated through the application component, the class library initiates the child application running request to the virtual server.

In some aspects, the child application running request is a request configured for initializing the child application. When the application component corresponding to the child application identifier receives the trigger operation, the class library interface invoking request is initiated through the application component. When receiving the class library interface invoking request, the class library triggers initialization of the child application, to initiate the child application running request to the virtual server, to request to initialize the child application.

In some aspects, the child application may be the mini program, and the child application identifier displayed on the service page is triggered. The class library interface invoking request is initiated through the application component. When receiving the class library interface invoking request initiated through the application component, the class library initiates the child application running request to the virtual server, to request to initialize the mini program.

In the foregoing aspects, the service page may be the complete page obtained by packaging the plurality of components, and the entry of the child application is encapsulated into the application component corresponding to the child application identifier. In this way, the entry of the child application may be accessed to different service pages without additional improvement of an implementation framework of the service page, so that the method for running a child application may be directly applied to an existing page, thereby improving adaptability of the method for running a child application.

In some aspects, the application program is the first parent application of the child application. When the child application running request is obtained by the virtual server, the obtaining a compiled package corresponding to the child application identifier through the virtual server, and parsing the package to obtain file data includes: downloading the compiled package corresponding to the child application identifier through the virtual server from a target server, the target server being configured to run the second parent application of the child application, and the first parent application and the second parent application being different application programs.

That the target server is configured to run the second parent application of the child application refers to that when the second parent application is run, communication with the target server needs to be performed, to obtain data needed for running the second parent application and provide another service for the second parent application. When the child application is run in the second parent application, communication with the target server also needs to be performed, to obtain the data needed for running the child application. The target server may be understood as a background server of the second parent application.

The package of the child application may be a package obtained by compiling by using an official development tool of the second parent application. To be specific, the package obtained by the virtual server is the same as a package loaded when the child application is started in the second parent application.

In the related art, the child application is usually run in the second parent application. Therefore, the compiled package of the child application is an existing package. The virtual server may directly obtain, without additionally developing the package for the application program, the package used for running the child application in the second parent application, thereby reducing time consumption and costs of implementing the method for running a child application.

For example, the second parent application is the instant communication application, and the child application is the mini program. In an actual application, the mini program is mainly run in the instant communication application. The background server (the target server) of the instant communication application has a package of the mini program. When the mini program is run in the browser, the virtual server may directly obtain the package of the mini program from the background server of the instant communication application.

In some aspects, the virtual server determines a download address of the package based on the child application running request, and obtains the compiled package of the child application from the target server based on the download address of the package.

In some aspects, the child application running request includes the identity number of the child application, and the virtual server obtains the identity number of the child application included in the child application running request, and determines the download address of the package based on the identity number of the child application. The virtual server generates a package obtaining request based on the download address, transmits the package obtaining request to the target server, and receives the compiled package transmitted by the target server.

In the foregoing aspects, the package obtained by the virtual server is the same as the package loaded when the child application is started in the second parent application, so that starting the child application in the application program based on the package has a native effect of starting the child application in the second parent application, and there is no need to additionally develop the package of the child application for the application program, thereby reducing the time consumption and the costs of implementing the method for running a child application. In addition, the package is the compiled package, and there is no need to perform a process of compiling based on the source code of the child application, so that efficiency of running the child application in the application program is high, and experience of wakening the child application through the application program is smoother.

In some aspects, the downloading the compiled package corresponding to the child application identifier from a target server through the virtual server includes: obtaining a package download address corresponding to the child application identifier from a proxy server through the virtual server; and downloading the compiled package corresponding to the child application identifier from the target server based on the package download address.

The terminal further includes the proxy server, and the proxy server may provide an address search service of the package.

In some aspects, when obtaining the child application running request, the virtual server transmits an address query request to the proxy server, and the proxy server returns the package download address corresponding to the child application identifier based on the address query request. After obtaining the package download address, the virtual server downloads the compiled package corresponding to the child application identifier from the target server based on the package download address.

In some aspects, the child application running request includes the identity number of the child application, and the obtaining a package download address corresponding to the child application identifier from a proxy server through the virtual server includes: generating an address query request corresponding to the identity number through the virtual server; transmitting the address query request to the proxy server, to indicate the proxy server to obtain the package download address corresponding to the child application identifier; and obtaining the package download address that corresponds to the child application identifier and is returned by the proxy server. The package download address corresponding to the child application identifier may be quickly obtained by transmitting the address query request to the proxy server.

In a possible scenario, the virtual server obtains the identity number included in the child application running request, generates the address query request based on the identity number, and transmits the address query request to the proxy server. The proxy server obtains the identity number in the address query request, queries for a version number of the child application identifier based on the identity number, and obtains a package download address corresponding to the version number. The proxy server may transmit the package download address corresponding to the version number to the virtual server, so that the virtual server obtains the package download address corresponding to the child application identifier. The version number may be a latest version number of the child application currently.

In another possible scenario, after obtaining the identity number in the address query request, the proxy server searches for a package list based on the identity number, the package list includes each package download address, and each package download address is a download address of each compiled package needed by starting the child application corresponding to the version number. The proxy server transmits the package list to the virtual server, so that the virtual server may determine the package download address based on the package list.

In some aspects, the terminal may include a child application runtime, the child application runtime may be used as an engine that runs the child application in the application program. When the child application is the mini program, the child application runtime may alternatively be denoted as a mini program runtime.

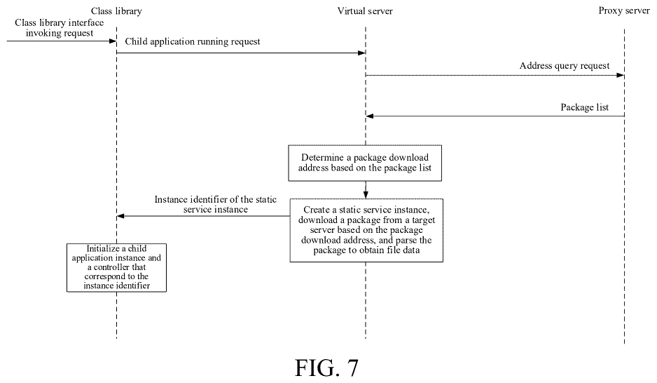

For example, as shown in FIG. 6, the child application runtime includes the application component, the class library, the virtual server, and the proxy server. As shown in FIG. 7, the child application runtime initiates, in response to the trigger operation on the child application identifier, the class library interface invoking request through the application component, the class library initiates the child application running request to the virtual server based on the class library interface invoking request, and the child application running request is configured for initializing the child application.

When obtaining the child application running request, the virtual server transmits the address query request to the proxy server based on the child application running request, the proxy server returns the package list to the virtual server based on the address query request, and the virtual server determines the package download address based on the package list. After determining the package download address, the virtual server creates a static service instance, downloads the package from the target server based on the package download address, and parses the package to obtain the file data, to complete creation of the static service instance. The virtual server returns an instance identifier of the static service instance to the class library. When the class library obtains the instance identifier, a child application instance and a controller that correspond to the instance identifier are initialized, to complete initialization of the child application.

The static service instance is configured for providing the file data obtained by parsing the package, and the child application instance is configured for implementing a function of the child application. For example, the child application instance encapsulates a code injector, and is configured for injecting a custom script to a native component of the child application. The child application instance further encapsulates an event emitter, and may be configured for processing a communication message from the virtual server and the proxy server, emitting an event, and the like. The child application instance further encapsulates a citation utility, and may be configured for citing a specific object of the native component. The controller provides the application program with a capability of controlling the child application, for example, provides a capability of creating, destructing, or restarting the child application.

In the foregoing aspects, the virtual server obtains the package download address from the proxy server, and then downloads the compiled package corresponding to the package download address from the target server, so that starting the child application in the application program based on the package has a native effect of starting the child application in the second parent application. In addition, there is no need to perform the process of compiling based on the source code of the child application, so that the efficiency of running the child application in the application program is high, and the experience of wakening the child application through the application program is smoother.

In some aspects, the running a child application corresponding to the child application identifier in the application program based on the file data includes: initiating a resource request including a virtual resource locator; obtaining the child application entry file corresponding to the virtual resource locator through the virtual server when the resource request is obtained by the virtual server; obtaining, in the file data, response data needed by the child application entry file; and running the child application corresponding to the child application identifier in the application program based on the child application entry file and the response data.

The resource locator refers to a uniform resource locator (URL), and may be configured to locate a specific location of a resource. The virtual resource locator (virtual URL) refers to that a specific location of the resource is in the virtual server.

The child application entry file is generated by the virtual server. The child application entry file may be understood as a main directory of the child application, and includes, but is not limited to, a basic library, a native component, and a file path that are needed for running the child application. The basic library and the native component that are included in the child application entry file provide a framework needed for running the child application. The file path included in the child application entry file may introduce the response data needed for running the child application, and the response data is page resource data needed for running the child application. The child application may be run through the child application entry file and the response data. In an actual application, the child application entry file may be marked as index. html, namely, the main directory of the child application.

In some aspects, the terminal may initiate the resource request through the class library, and when the class library initiates the resource request, an obtaining event is triggered. When the virtual server detects the obtaining event, the virtual server may intercept the resource request initiated by the class library, that is, the resource request is obtained by the virtual server. An action of detecting the obtaining event by the virtual server may be continuously performed, to ensure that the virtual server can intercept the resource request initiated by the class library.

The virtual server obtains the virtual URL included in the resource request, obtains the corresponding child application entry file based on the virtual URL, and returns the child application entry file to the class library, so that the class library obtains the child application entry file. The terminal executes the child application entry file through the class library, and in a process of executing the child application entry file, obtains the response data from the file data of the virtual server based on the file path included in the child application entry file. The class library runs the child application in the application program based on the child application entry file and the response data.

In the foregoing aspects, the virtual server intercepts the resource request, so that the resource request is not actually transmitted. Instead, the resource request is processed through the virtual server, to obtain the child application entry file. The response data needed for running the child application is obtained through the child application entry file, and the child application is directly run in the application program based on the child application entry file and the response data, thereby greatly reducing operation complexity of running the child application.

In some aspects, the initiating a resource request including a virtual resource locator includes: creating an embedded page frame instance, a location pointing to an external resource in the embedded page frame instance being the virtual resource locator; and initiating, through the embedded page frame instance, the resource request including the virtual resource locator. The embedded page frame instance is created, and the resource request is initiated through the embedded page frame instance, to facilitate subsequent loading of the embedded page frame instance through the obtained data, to embed a page for running the child application into the service page, so that the child application is directly run in the application program, thereby greatly reducing the operation complexity of running the child application.

The embedded page frame instance refers to an iframe instance, iframe is a label of html, and html is a language for describing a web page. The iframe instance may be configured for embedding a page into a page. In this aspect of this disclosure, the page for running the child application is embedded into the service page by creating the embedded page frame instance.

The location pointing to the external resource is an attribute of the embedded page frame instance, and is configured for defining an address of a document embedded in the iframe instance.

The terminal creates the iframe instance through the class library, and src (the location pointing to the external resource) of the iframe instance is the virtual URL. The class library runs the iframe instance, to initiate the resource request including the virtual URL. The class library may create the iframe instance after initialization of the child application instance and the controller is completed.

In some aspects, the obtaining, in the file data, response data needed by the child application entry file includes: initiating, through the embedded page frame instance, a file obtaining request based on the file path included in the child application entry file; and obtaining, in the file data through the file obtaining request, the response data needed by the child application entry file.

The child application entry file includes the file path. Because the child application entry file is generated by the virtual server, and the file path is a storage path of the file data in the virtual server, the corresponding response data may be searched from the file data in the virtual server based on the file path included in the child application entry file.

The resource request initiated by the class library is intercepted by the virtual server. The virtual server returns the child application entry file based on the virtual URL included in the resource request. The terminal executes the child application entry file through the iframe instance created through the class library, generates the file obtaining request based on the file path included in the child application entry file, and transmits the file obtaining request to the virtual server. After receiving the file obtaining request, the virtual server obtains the corresponding response data from the file data based on the file path included in the file obtaining request, and transmits the response data to the class library. The class library loads the iframe instance based on the child application entry file and the response data, to run the child application in the application program.

In the foregoing aspects, the child application entry file is executed through the embedded page frame instance, to initiate the file obtaining request including the file path, and the response data corresponding to the file path is obtained from the virtual server. Further, the embedded page frame instance is loaded based on the child application entry file and the response data, to embed the page for running the child application into the service page, so that the child application is directly run in the application program, thereby greatly reducing the operation complexity of running the child application. Because running of the child application involves less data, the child application may be quickly run and started in the application program.

In some aspects, after the parsing the package to obtain file data, the method for running a child application further includes: storing the file data in a cache area of the virtual server; and the obtaining, in the file data, response data needed by the child application entry file includes: obtaining, based on the file data in the cache area, the response data needed by the child application entry file.

In some aspects, the package of the child application is downloaded through the virtual server, the package is parsed, and the virtual server stores the file data obtained by parsing the package in the cache area. The terminal transmits the file obtaining request to the virtual server through the class library, and the virtual server obtains the response data corresponding to the file obtaining request in the cache area.

In some aspects, the file obtaining request includes the file path. After receiving the file obtaining request, the virtual server obtains the file path included in the file obtaining request, and obtains, based on the file path, the corresponding response data in the file data stored in the cache area.

In the foregoing aspects, the virtual server stores, in the cache area, the file data obtained by parsing the package, and manages the file data in the cache area. The virtual server serves as a regular service thread of the application program, and provides a resource processing service of the child application for the application program, so that the application program may obtain the data needed for running the child application from the virtual server, to facilitate running of the child application performed by the application program based on the file data in the cache area, thereby directly running the child application in the application program, and greatly reducing the operation complexity of running the child application.

In some aspects, the method for running a child application further includes: when the response data needed by the child application entry file is not obtained in the cache area, downloading, from the target server through the virtual server, the response data needed by the child application entry file. The resource processing service of the child application is provided for the application program through the virtual server, so that the application program may obtain the data needed for running the child application from the virtual server, thereby directly running the child application in the application program, and greatly reducing the operation complexity of running the child application.

It can be known from the foregoing aspects that, the response data needed by the child application entry file is obtained in the cache area in a manner in which the file obtaining request is initiated through the file path included in the child application entry file and the response data corresponding to the file path is obtained in the cache area. Therefore, when the response data needed by the child application entry file is not obtained in the cache area, it indicates that the response data corresponding to the file path is missing in the cache area, and it may be that the package is not downloaded successfully or is lost accidentally, and the virtual server may re-download the response data needed by the child application entry file from the target server.

In some aspects, the downloading, from the target server through the virtual server, the response data needed by the child application entry file includes: downloading a supplementary package from the target server through the virtual server, and parsing the supplementary package to obtain supplementary file data; storing the supplementary file data in the cache area; and obtaining, based on the supplementary file data in the cache area, the response data needed by the child application entry file.

The virtual server may generate the address query request based on the file path, and transmit the address query request to the proxy server. The proxy server returns a download address of the supplementary package based on the address query request. The virtual server obtains the download address of the supplementary package from the target server. The virtual server downloads the supplementary package from the target server based on the download address of the supplementary package.

The virtual server may generate the address query request based on the file path, to be specific, the virtual server may query the download address of the supplementary package in the package list based on the file path, and generate the address query request based on the file path if the download address of the supplementary package is not found in the package list.

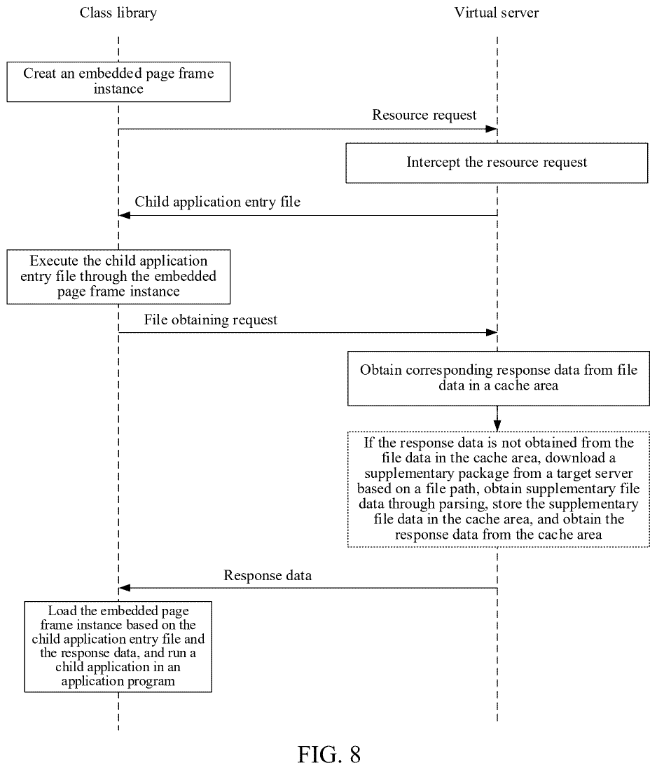

For example, as shown in FIG. 8, after completing initialization of the child application instance and the controller, the class library creates the embedded page frame instance (the iframe instance). The class library runs the iframe instance, to initiate the resource request including the virtual URL. The virtual server intercepts the resource request, and returns the child application entry file based on the resource request. The class library executes the child application entry file through the iframe instance, and initiates the file obtaining request to the virtual server based on the file path included in the child application entry file. The virtual server obtains the corresponding response data from the file data in the cache area based on the file obtaining request, and transmits the response data to the class library. If the virtual server does not obtain the corresponding response data from the file data in the cache area, the virtual server downloads the supplementary package from the target server based on the file path. The virtual server parses the supplementary package to obtain the supplementary file data, stores the supplementary file data to the cache area, obtains the response data corresponding to the file obtaining request in the cache area, and transmits the response data to the class library. The class library loads the iframe instance based on the child application entry file and the response data, to run the child application in the application program.

In the foregoing aspects, when the virtual server does not obtain the response data in the cache area, the virtual server re-downloads the supplementary package from the target server, and stores the supplementary package in the cache area, so that when the child application needs to be run in the application program subsequently, the needed response data may be directly obtained in the cache area, thereby avoiding repeatedly obtaining the data, reducing resource consumption, and also improving the efficiency of running the child application in the application program.

In some aspects, the method for running a child application further includes: obtaining a target identity bill in response to a target interface invoking operation triggered in the child application run in the application program, the target identity bill being an identity bill of the target object in the second parent application; generating a target interface invoking request carrying the target identity bill; and verifying the target identity bill through the proxy server, and forwarding the target interface invoking request to the target server when verification of the target identity bill succeeds.

The target interface invoking operation is configured to invoke an interface of the target server. In an actual application, invoking the interface of the target server may be for obtaining a communication number bound between the target object and the second parent application, or may be for obtaining a friendship of the target object in the second parent application. An operation implemented by invoking the interface of the target server when the child application is run in the second parent application may alternatively be implemented by invoking the interface of the target server when the child application is run in the application program.

The target identity bill may reflect identity information of the target object in the second parent application.

When the child application run in the application program needs to invoke the interface of the target server, the initiated target interface invoking request needs to carry the target identity bill, to facilitate authentication performed by the proxy server based on the target identity bill, and the target interface invoking request is forwarded to the target server after the authentication succeeds, so that when the target object runs the child application in the application program, the target object may invoke the interface of the target server based on the target identity bill. Further, the operation executed when the child application is run in the application program may be the same as the operation executed when the child application is run in the second parent application, that is, the operation has a native effect of running the child application in the second parent application.

In some aspects, the method for running a child application further includes: obtaining a target identity bill in response to a login operation triggered in the child application run in the application program, the target identity bill being an identity bill of a target object in the second parent application; generating a parent application interface invoking request carrying the target identity bill; and verifying the target identity bill through the proxy server, and transmitting the parent application interface invoking request to the target server through the proxy server when verification of the target identity bill succeeds, the parent application interface invoking request being configured for indicating the target server to log in to the child application based on a target account of the target object in the second parent application.

The target account is an account registered by the target object in the second parent application, that is, the target object may log in to the second parent application through the target account. The login operation refers to logging in to the child application run in the application program through the target account.

The parent application interface invoking request is configured for invoking a parent application interface, and the parent application interface is an interface belonging to the target server.

In some aspects, for the child application run in the application program, a main page of the child application includes a login component, and the login operation may be triggered through the login component. When the login operation is triggered through the login component, the login component obtains the target identity bill of the target object in the second parent application, generates the parent application interface invoking request, and transmits the parent application interface invoking request carrying the target identity bill to the proxy server. The target identity bill is verified through the proxy server, and that the verification succeeds indicates that an identity of the target object corresponding to the target identity bill is legal. Further, the proxy server transmits the parent application interface invoking request to the target server. The target server obtains the target account of the target object in the second parent application in response to the parent application interface invoking request, and logs in to the child application in the application program based on the target account of the target object.

That the target server logs in to the child application in the application program based on the target account of the target object may be that the target server sets a login state of the target object in the child application (run in the application program) as logged in, and transmits post-login page data to the terminal, so that the terminal displays a post-login page of the child application in the application program based on the post-login page data.

For example, the first parent application is the browser, the second parent application is the instant communication application, and the child application is the mini program. In a process of running the mini program in the browser, when the mini program needs to be logged in to in the browser through the target account of the target object in the instant communication application, the target identity bill of the target object in the instant communication application is obtained. The target identity bill is authenticated through the proxy server. When the authentication succeeds, the proxy server transmits the parent application interface invoking request to the target server. The target server logs in to the mini program run in the browser through the target account of the target object in the instant communication application.

In the foregoing aspects, when the child application run in the application program needs to invoke the parent application interface of the target server, the parent application interface invoking request carrying the target identity bill is generated, the target identity bill is authenticated through the proxy server, and the parent application interface invoking request is transmitted to the target server when the authentication succeeds, thereby ensuring data security of the target server. In addition, the child application run in the application program may invoke the interface of the target server, so that functions used when the child application is run in the second parent application can all be used when the child application is run in the application program, and the second parent application does not need to participate in this process, thereby reducing the operation complexity of running the child application and improving the efficiency of running the child application.

In some aspects, the obtaining the target identity bill includes: obtaining a service identity bill of the target object on the service page; and obtaining the target identity bill of the target object in the second parent application based on the service identity bill through the virtual server.

The virtual server is further configured to manage the bill. The service identity bill may be configured for reflecting identity information of the target object on the service page. In an actual application, the identity information of the target object on the service page may be different from the identity information of the target object in the second parent application.

In some aspects, the terminal obtains the service identity bill of the target object on the service page from a service server of the service page, and transmits the service identity bill to the virtual server. The virtual server determines the target identity bill of the target object in the second parent application based on the service identity bill, to exchange for the target identity bill through the service identity bill.

In some aspects, that the terminal obtains the service identity bill of the target object on the service page from a service server of the service page may be that, the terminal transmits a bill obtaining request to the proxy server through a front end of the service page, the proxy server forwards the bill obtaining request to the service server of the service page, and the service server returns the service identity bill of the target object on the service page based on the bill obtaining request, so that the terminal obtains the service identity bill on the service page.

In some aspects, the terminal may obtain the service identity bill in advance, and exchange for the target identity bill. For example, the terminal may obtain the service identity bill of the target object on the service page while initiating the child application running request, and exchange for the target identity bill based on the service identity bill; or may obtain the service identity bill of the target object on the service page after starting the child application in the application program, and exchange for the target identity bill based on the service identity bill.

In some aspects, service identity bills of the target object on different service pages are different. The target identity bills exchanged for based on the different service identity bills of the target object are the same, so that when running the child application on different service pages, the target object may invoke the interface of the target server through the same target identity bills.

In some aspects, the method for running a child application further includes: obtaining a validity period bill corresponding to the target identity bill; and the generating a parent application interface invoking request carrying the target identity bill includes: generating, when it is determined, based on the validity period bill, that the target identity bill is valid, the parent application interface invoking request carrying the target identity bill.

In some aspects, the method for running a child application further includes: when it is determined, based on the validity period bill, that the target identity bill is invalid, obtaining an updated target identity bill based on the validity period bill; and generating a parent application interface invoking request carrying the updated target identity bill.

In some aspects, while the target identity bill of the target object in the second parent application is obtained through the virtual server, the validity period bill corresponding to the target identity bill may further be obtained. The validity period bill includes effective duration corresponding to the target identity bill. Before generating the parent application interface invoking request carrying the target identity bill, the terminal may first determine, based on the validity period bill, whether the target identity bill is valid. If duration between a current moment and a moment at which the target identity bill is obtained is less than or equal to the effective duration, it is determined that the target identity bill is valid, so that the parent application interface invoking request carrying the target identity bill is generated. If duration between a current moment and a moment at which the target identity bill is obtained is greater than the effective duration, it is determined that the target identity bill is invalid, so that the validity period bill is transmitted to the virtual server. The updated target identity bill is obtained through the virtual server, and the terminal may generate the parent application interface invoking request carrying the updated target identity bill.

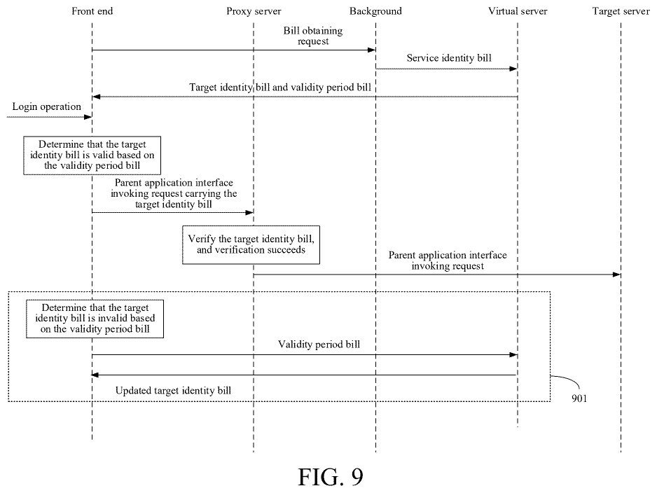

For example, as shown in FIG. 9, the terminal obtains the service identity bill of the target object on the service page, and initiates the bill obtaining request through the front end of the service page. A background of the service page obtains the service identity bill based on the bill obtaining request, and transmits the service identity bill to the virtual server. The virtual server returns the target identity bill and the corresponding validity period bill to the application component based on the service identity bill. The front end generates, in response to the login operation triggered on the child application and when it is determined, based on the validity period bill, that the target identity bill is valid, the parent application interface invoking request carrying the target identity bill; transmits the parent application interface invoking request carrying the target identity bill to the proxy server; verifies the target identity bill through the proxy server; and transmits the parent application interface invoking request to the target server through the proxy server when the verification succeeds, to login to the child application through the target account. When it is determined, based on the validity period bill, that the target identity bill is invalid (content in a dashed-line box 901 in FIG. 9), the validity period bill is transmitted to the virtual server through the front end, the virtual server returns the updated target identity bill to the application component, and the invalid target identity bill is replaced with the updated target identity bill, to facilitate login to the child application by the front end through the target account based on the updated target identity bill.

In the foregoing aspects, the target identity bill of the target object in the second parent application is exchanged for through the virtual server based on the service identity bill of the target object on the service page, to facilitate subsequent invoking of the interface of the target server through the target identity bill.

In some aspects, the method for running a child application further includes: transmitting a service interface invoking request to the service server through the proxy server in response to a service interface invoking operation triggered in the child application run in the application program, the service interface invoking request being configured for indicating the service server to return corresponding service data; and receiving the service data, and displaying a service sub-page in the child application based on the service data.

The service interface invoking request is configured for invoking a service interface, and the service interface is an interface belonging to the service server.

The service data is data obtained from the service interface, and is configured for displaying the service sub-page of the child application. The service sub-page may be a secondary page of the child application. For example, the service sub-page may be entered through the main page of the child application, that is, compared with the main page, the service sub-page is the secondary page.

In some aspects, the main page of the child application includes a sub service entry component. In response to the service interface invoking operation triggered for the sub service entry component of the child application, the service interface invoking request is generated through the class library. The class library transmits the service interface invoking request to the proxy server. The proxy server forwards the service interface invoking request to the service server. The service server obtains the corresponding service data in response to the service interface invoking request, transmits the service data to the proxy server, and returns the service data to the class library through the proxy server. The class library displays the service sub-page based on the service data.

In some aspects, the main page of the child application includes a plurality of sub service entry components. Different service sub-pages may be respectively entered through the sub service entry components, and service data needed for displaying the different service sub-pages is also different. The service interface invoking request includes a page identifier of the service sub-page. The service server obtains the corresponding service data based on the page identifier, so that the class library may display the service sub-page corresponding to the page identifier based on the service data.

In some aspects, the page identifier is associated with the sub service entry component. When the sub service entry component is triggered, the page identifier associated with the sub service entry component is obtained through the class library. The class library generates the service interface invoking request based on the page identifier, and forwards the service interface invoking request to the service server through the proxy server. The service server obtains the page identifier included in the service interface invoking request, and obtains the corresponding service data based on the page identifier.

In the foregoing aspects, when the child application run in the application program needs to obtain the service data, because the application program and the service server belong to different autonomous systems, the service interface invoking request is forwarded to the service server through the proxy server, to obtain the service data. The service sub-page is displayed through the service data. A limitation that the application program cannot invoke an interface across systems is resolved through the proxy server, so that the child application run in the application program may invoke the interface of the service server. Further, functions in which the service server needs to participate in the child application can all be normally used.

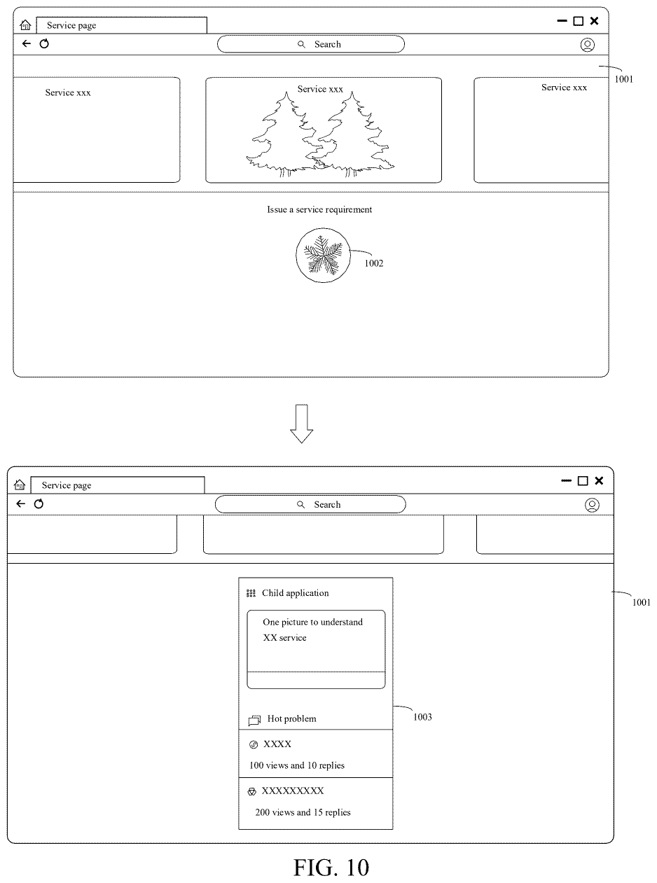

In some aspects, a method for running a child application may be applied to a scenario in which a mini program is run in a browser. As shown in FIG. 10, in a process of executing a service through a service page 1001 of the browser, a service requirement needs to be issued through the mini program corresponding to the service page 1001. The service page 1001 includes a mini program identifier (a child application identifier) 1002. When the mini program identifier 1002 is triggered, a sub-page is displayed on the service page 1001, a child application running request is initiated, a compiled package is obtained through a virtual server, and the package is parsed to obtain file data. The mini program is run in the browser based on the file data, and a main page 1003 of the mini program is displayed through the sub-page of the service page.

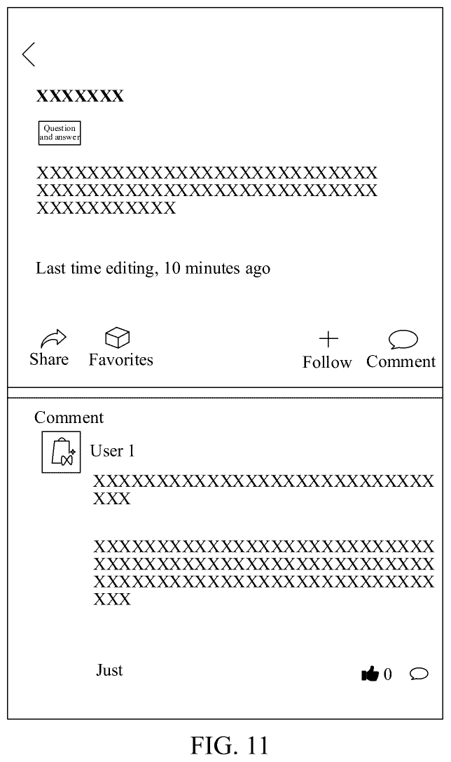

The main page 1003 of a child application run in an application program includes sub service entry components. A sub service entry component 1004 is an entry component of a problem detail page. A service interface invoking request is generated in response to a service interface invoking operation triggered on the sub service entry component 1004, and the service interface invoking request includes a page identifier of the problem detail page. The service interface invoking request is transmitted to a service server through a proxy server, and the service server obtains service data of the problem detail page through the page identifier, transmits the service data of the problem detail page to the proxy server, and returns the service data to a class library through the proxy server. The class library displays the problem detail page based on the service data, and the problem detail page is shown in FIG. 11.

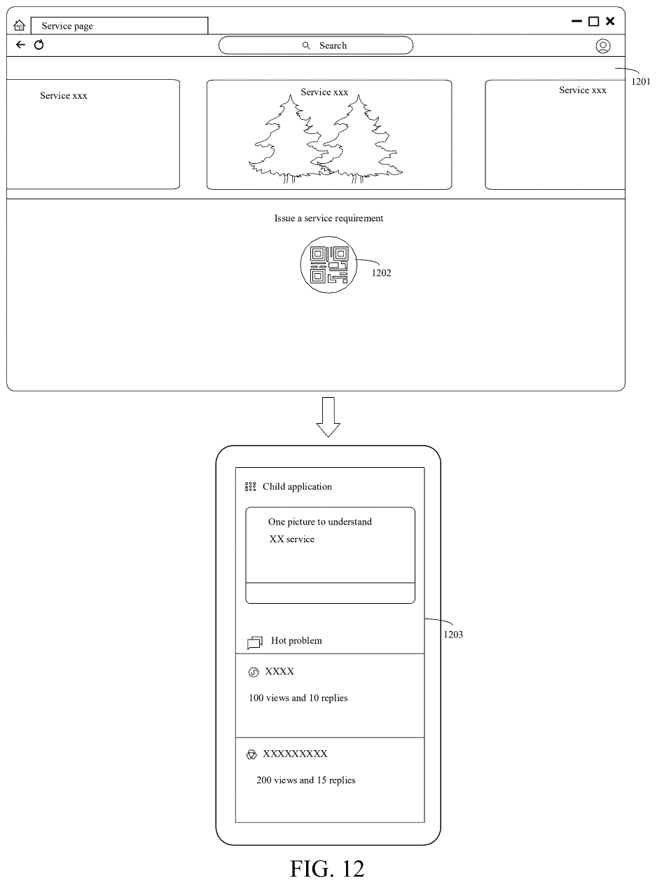

In the related art, as shown in FIG. 12, a terminal runs a browser, displays a service page 1201 through the browser, and executes a service on the service page 1201. When the service executed on the service page 1201 needs to complete at least one link through a mini program, a graphic code 1202 of the mini program may be displayed on the service page 1201, the graphic code 1202 is scanned through a second parent application run on a mobile device (for example, a mobile phone), and a main page 1203 of the mini program is displayed in the second parent application.

In the aspects of this disclosure, the child application may be directly run through the application program. Compared with the related art, operation complexity of running the child application is greatly reduced.

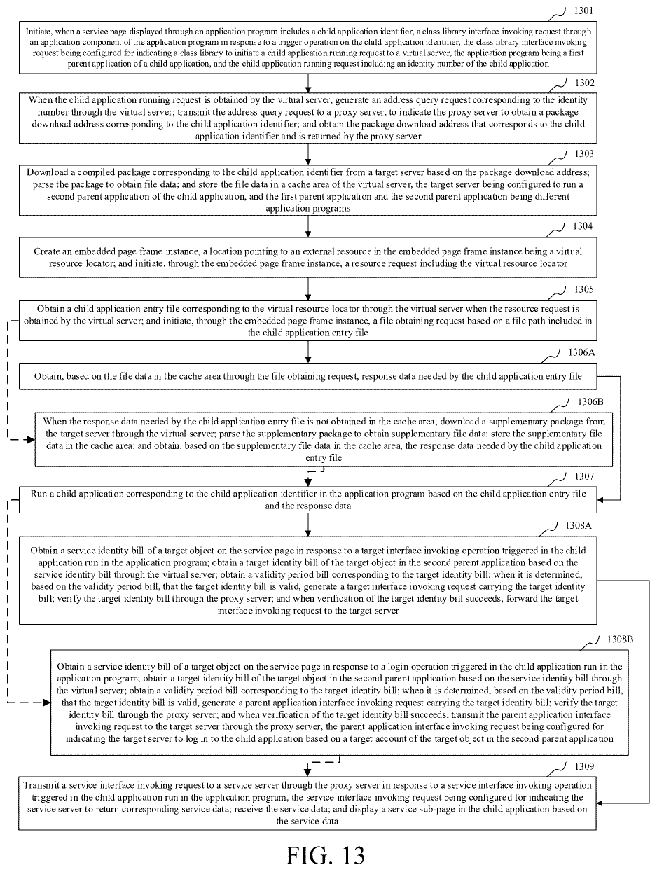

In some aspects, as shown in FIG. 13, a method for running a child application includes the following operations.

Operation 1301: Initiate, when a service page displayed through an application program includes a child application identifier, a class library interface invoking request through an application component of the application program in response to a trigger operation on the child application identifier, the class library interface invoking request being configured for indicating a class library to initiate a child application running request to a virtual server, the application program being a first parent application of a child application, and the child application running request including an identity number of the child application.

Operation 1302: When the child application running request is obtained by the virtual server, generate an address query request corresponding to the identity number through the virtual server; transmit the address query request to a proxy server, to indicate the proxy server to obtain a package download address corresponding to the child application identifier; and obtain the package download address that corresponds to the child application identifier and is returned by the proxy server.

Operation 1303: Download a compiled package corresponding to the child application identifier from a target server based on the package download address; parse the package to obtain file data; and store the file data in a cache area of the virtual server, the target server being configured to run a second parent application of the child application, and the first parent application and the second parent application being different application programs.

Operation 1304: Create an embedded page frame instance, a location pointing to an external resource in the embedded page frame instance being a virtual resource locator; and initiate, through the embedded page frame instance, a resource request including the virtual resource locator.

Operation 1305: Obtain a child application entry file corresponding to the virtual resource locator through the virtual server when the resource request is obtained by the virtual server; and initiate, through the embedded page frame instance, a file obtaining request based on a file path included in the child application entry file.

Operation 1306A: Obtain, based on the file data in the cache area through the file obtaining request, response data needed by the child application entry file.

Operation 1306B: When the response data needed by the child application entry file is not obtained in the cache area, download a supplementary package from the target server through the virtual server; parse the supplementary package to obtain supplementary file data; store the supplementary file data in the cache area; and obtain, based on the supplementary file data in the cache area, the response data needed by the child application entry file.

Operation 1307: Run a child application corresponding to the child application identifier in the application program based on the child application entry file and the response data.

Operation 1308A: Obtain a service identity bill of a target object on the service page in response to a target interface invoking operation triggered in the child application run in the application program; obtain a target identity bill of the target object in the second parent application based on the service identity bill through the virtual server; obtain a validity period bill corresponding to the target identity bill; when it is determined, based on the validity period bill, that the target identity bill is valid, generate a target interface invoking request carrying the target identity bill; verify the target identity bill through the proxy server; and when verification of the target identity bill succeeds, forward the target interface invoking request to the target server.

Operation 1308B: Obtain a service identity bill of a target object on the service page in response to a login operation triggered in the child application run in the application program; obtain a target identity bill of the target object in the second parent application based on the service identity bill through the virtual server; obtain the validity period bill corresponding to the target identity bill; when it is determined, based on the validity period bill, that the target identity bill is valid, generate a parent application interface invoking request carrying the target identity bill; verify the target identity bill through the proxy server; and when verification of the target identity bill succeeds, transmit the parent application interface invoking request to the target server through the proxy server, the parent application interface invoking request being configured for indicating the target server to log in to the child application based on a target account of the target object in the second parent application.

Operation 1309: Transmit a service interface invoking request to a service server through the proxy server in response to a service interface invoking operation triggered in the child application run in the application program, the service interface invoking request being configured for indicating the service server to return corresponding service data; receive the service data; and display a service sub-page in the child application based on the service data.

In the foregoing method for running a child application, the child application identifier is displayed on the service page of the application program, and in response to the trigger operation on the child application identifier, the child application running request is initiated. When the child application running request is obtained by the virtual server, the compiled package corresponding to the child application identifier is obtained through the virtual server, the package is parsed to obtain the file data, and the child application is run in the application program through the file data. In other words, the child application may be directly run in the application program by triggering the child application identifier on the service page of the application program. Compared with a solution in the related art in which a mobile device scans a graphic code of the child application displayed in the application program and the child application is run in the mobile device, the child application is directly run in the application program, which greatly reduces operation complexity of running the child application and improves efficiency of running the child application. In addition, because the virtual server obtains the compiled package, the virtual server may directly parse the package, and run, through the file data obtained through parsing, the child application without executing a compiling process, so that efficiency of running the child application in the application program is high, and a process of wakening the child application through the application program is smoother.

Although the operations in the flowcharts involved in the embodiments are shown in sequence as indicated by the arrows, the operations are not necessarily executed in sequence indicated by the arrows. Unless explicitly descriptions in this specification, there is no strict sequence restriction on the execution of the operations, and the operations can be executed in another sequence. In addition, at least some of the operations in the flowcharts involved in aspects may include a plurality of operations or phases. The operations or phases are not necessarily executed at the same time, but may be executed at different times. The execution sequence of the operations or phases is not necessarily in sequence, but may be executed in turn or alternately with another operation or at least part of the operation or phases in another operation.

Based on a similar concept, the aspects of this disclosure further provide an apparatus for running a child application that is configured to implement the foregoing method for running a child application. The implementation solution provided by the apparatus to solve the problem is similar to the implementation solution recorded in the foregoing method. Therefore, for examples of specific limitations in one or more apparatus aspects for running a child application provided below, reference can be made to the foregoing method for running a child application.

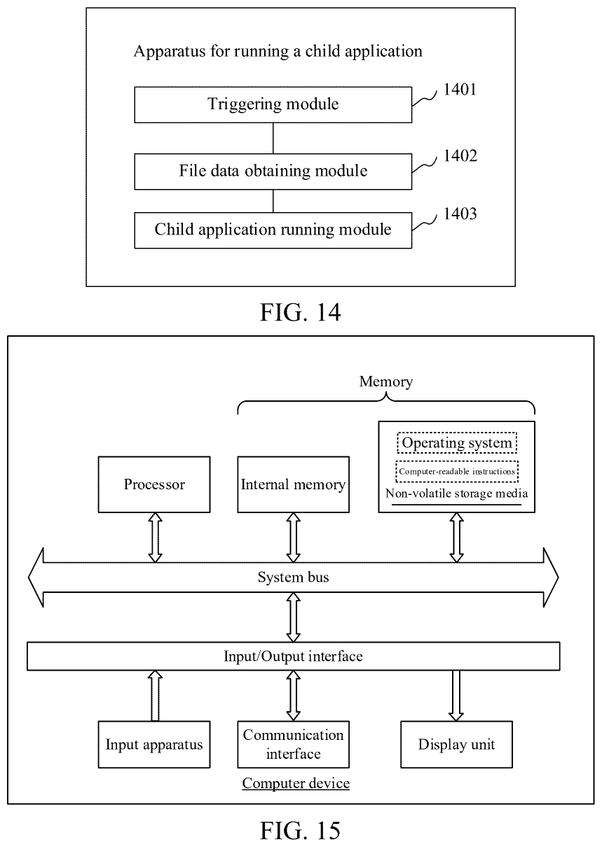

In an aspect, as shown in FIG. 14, an apparatus for running a child application is provided, including a triggering module 1401, a file data obtaining module 1402, and a child application running module 1403.

The triggering module 1401 is configured to: initiate, when a service page displayed through an application program includes a child application identifier, a child application running request in response to a trigger operation on the child application identifier.

The file data obtaining module 1402 is configured to: when the child application running request is obtained by a virtual server, obtain a compiled package corresponding to the child application identifier through the virtual server, and parse the package to obtain file data.

The child application running module 1403 is configured to run a child application corresponding to the child application identifier in the application program based on the file data.

In some aspects, the triggering module 1401 is further configured to initiate a class library interface invoking request through an application component of the application program in response to the trigger operation on the child application identifier, the class library interface invoking request being configured for indicating a class library to initiate the child application running request to the virtual server.

In some aspects, the application program is a first parent application of the child application, the file data obtaining module 1402 includes a package downloading unit, and the package downloading unit is configured to download the compiled package corresponding to the child application identifier from a target server through the virtual server, the target server being configured to run a second parent application of the child application, and the first parent application and the second parent application being different application programs.

In some aspects, the package downloading unit is further configured to: obtain a package download address corresponding to the child application identifier from a proxy server through the virtual server; and download the compiled package corresponding to the child application identifier from the target server based on the package download address.

In some aspects, the child application running request includes an identity number of the child application, and the package downloading unit is further configured to: generate an address query request corresponding to the identity number through the virtual server; transmit the address query request to the proxy server, to indicate the proxy server to obtain the package download address corresponding to the child application identifier; and obtain the package download address that corresponds to the child application identifier and is returned by the proxy server.

In some aspects, the child application running module 1403 includes:

a resource request transmitting unit, configured to initiate a resource request including a virtual resource locator;

a child application entry file obtaining unit, configured to obtain a child application entry file corresponding to the virtual resource locator through the virtual server when the resource request is obtained by the virtual server;

a response data obtaining unit, configured to: obtain, in the file data, response data needed by the child application entry file; and

a running unit, configured to run the child application corresponding to the child application identifier in the application program based on the child application entry file and the response data.

In some aspects, the resource request transmitting unit is further configured to: create an embedded page frame instance, a location pointing to an external resource in the embedded page frame instance being the virtual resource locator; and initiate, through the embedded page frame instance, the resource request including the virtual resource locator, and the response data obtaining unit is further configured to: initiate, through the embedded page frame instance, a file obtaining request based on a file path included in the child application entry file; and obtain, in the file data through the file obtaining request, the response data needed by the child application entry file.

In some aspects, the file data obtaining module 1402 is further configured to store the file data in a cache area of the virtual server, and the response data obtaining unit is further configured to: obtain, based on the file data in the cache area, the response data needed by the child application entry file.

In some aspects, the response data obtaining unit is further configured to: when the response data needed by the child application entry file is not obtained in the cache area, download, from the target server through the virtual server, the response data needed by the child application entry file.

In some aspects, the response data obtaining unit is further configured to: download a supplementary package from the target server through the virtual server, and parse the supplementary package to obtain supplementary file data; store the supplementary file data in the cache area; and obtain, based on the supplementary file data in the cache area, the response data needed by the child application entry file.

In some aspects, the apparatus for running a child application further includes: an interface invoking module, configured to: obtain a target identity bill in response to a target interface invoking operation triggered in the child application run in the application program, the target identity bill being an identity bill of a target object in the second parent application; generate a target interface invoking request carrying the target identity bill; and verify the target identity bill through the proxy server, and forward the target interface invoking request to the target server when verification of the target identity bill succeeds.

In some aspects, the apparatus for running a child application further includes: a login module, configured to: obtain a target identity bill in response to a login operation triggered in the child application run in the application program, the target identity bill being an identity bill of a target object in the second parent application; generate a parent application interface invoking request carrying the target identity bill; and verify the target identity bill through the proxy server, and transmit the parent application interface invoking request to the target server through the proxy server when verification of the target identity bill succeeds, the parent application interface invoking request being configured for indicating the target server to log in to the child application based on a target account of the target object in the second parent application.

In some aspects, the login module is further configured to: obtain a service identity bill of the target object on the service page; and obtain the target identity bill of the target object in the second parent application based on the service identity bill through the virtual server.

In some aspects, the apparatus for running a child application further includes a bill validity verification module, configured to obtain a validity period bill corresponding to the target identity bill; and the generating a parent application interface invoking request carrying the target identity bill includes: generating, when it is determined, based on the validity period bill, that the target identity bill is valid, the parent application interface invoking request carrying the target identity bill.

In some aspects, the apparatus for running a child application further includes a service sub-page display module 1401, configured to: transmit a service interface invoking request to a service server through the proxy server in response to a service interface invoking operation triggered in the child application run in the application program, the service interface invoking request being configured for indicating the service server to return corresponding service data; and receive the service data, and display a service sub-page in the child application based on the service data.

All or a part of each module of the apparatus for running a child application may be implemented through software, hardware, and a combination of the software and the hardware thereof. Each module may be embedded in or independent of the processor of the computer device in a form of the hardware, or may be stored in the memory of the computer device in a form of the software, to enable the processor to execute operations corresponding to the modules.

In an aspect, a computer device is provided. The computer device may be a terminal, and an internal structure may be shown in FIG. 15. The computer device includes processing circuitry, such as a processor, a memory, an input/output interface, a communication interface, a display unit and an input apparatus. The processor, the memory, and the input/output interface are connected through a system bus. The communication interface, the display unit and the input apparatus are connected to the system bus through the input/output interface. The processor of the computer device is configured to provide a computing and control capability. The memory of the computer device includes a non-volatile storage media and an internal memory. The non-volatile storage media stores an operating system and a computer program. The internal memory provides an environment for execution of the operating system and the computer program in the non-volatile storage media. The input/output interface of the computer device is configured to exchange information between the processor and an external device. The communication interface of the computer device is configured to communication with an external terminal in a wired or wireless manner. The wireless manner may be implemented through Wi-Fi, a mobile cellular network, NFC (near field communication) or another technology. When the computer program is executed by the processor, the method for running a child application is implemented. The display unit of the computer device is configured to form a visually visible picture and may be a display screen, a projection device or a virtual reality imaging device. The display screen may be a liquid crystal display or an electronic ink display. The input device of the computer device may be a touch layer covered on the display screen, or may alternatively be a button, a trackball or a touch pad provided on a computer device shell, or may alternatively be an external keyboard, a touch pad or a mouse.

A person skilled in the art may understand that, the structures shown in FIG. 15 are merely block diagrams of some structures related to solutions of this disclosure, and may not constitute limitation on the computer device to which the solutions of this disclosure is applied. A specific computer device may include more or fewer components than those shown in the figure, or some components may be combined, or a different component deployment may be used.

In an aspect, a computer device is provided, including a memory and one or more processors, the memory storing computer-readable instructions, and the computer-readable instructions, when executed by the processor, causing the one or more processors to implement the foregoing method for running a child application.

In an aspect, one or more non-volatile readable storage media are provided, having computer-readable instructions stored therein, and the computer-readable instructions, when executed by the processor, causing one or more processors to implement the foregoing method for running a child application.

In an aspect, a computer program product is provided, including computer-readable instructions, and the computer-readable instructions, when executed by a processor, implementing the foregoing method for running a child application.

A person of ordinary skill in the art may understand that all or some of the processes of the methods in the aspects may be implemented by indicating related hardware through a computer program. The computer program may be stored in a non-volatile computer-readable storage medium, such as a non-transitory computer-readable storage medium. When the computer program is executed, the computer-readable instructions may include the processes of the foregoing method aspects. Any reference to the memory, the database or another media used in aspects provided by this disclosure may include at least one of the non-volatile memory and the volatile memory. The non-volatile memory can include a read-only memory (Read-Only Memory, ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM), an external cache memory, or the like. For description and not a limitation, the RAM may be in various forms, such as a static random access memory (SRAM), or a dynamic random access memory (DRAM). The databases involved in the various aspects provided by this disclosure may include at least one of a relational database and a non-relational database. The non-relational databases may include a blockchain-based distributed databases, and the like. This is not limited. The processors and/or processing circuitry involved in aspects provided by this disclosure may be a general-purpose processor, a central processing unit, a graphics processor, a digital signal processor, a programmable logic device, a quantum computing-based data processing logic device, and the like. This is not limited.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

Technical features of foregoing aspects may be combined in different manners to form other aspects. For ease of description, not all possible combinations of the technical features in aspects are described. However, as long as there is no contradiction in the combinations of these technical features, it is to be considered to be within the scope of this disclosure.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Aspects only describe several implementations of this disclosure and are not to be understood as limitations of the scope of this disclosure. A person of ordinary skill in the art can further make several improvements and refinements without departing from the concept of this disclosure, and the modifications and improvements shall fall within the scope of this disclosure.

What is claimed is:

1. A computer-implemented method for running a child application within a first parent application on a terminal, the method comprising:
displaying, via the first parent application, a service page including a child application identifier;
initiating, in response to a user operation on the child application identifier, a request to run the child application;
in response to the request:
obtaining, via a virtual server, a compiled package corresponding to the child application identifier; and
parsing the compiled package to obtain file data associated with the child application; and
running the child application in the first parent application based on the file data.

2. The method according to claim 1, wherein the initiating the request to run the child application comprises:
invoking a class library interface through an application component of the first parent application.

3. The method according to claim 1, wherein
the child application is a mini program,
the obtaining the compiled package includes downloading the compiled package corresponding to the child application identifier from a target server through the virtual server, and
the target server is configured to run a second parent application of the child application, the first parent application and the second parent application being different application programs.

4. The method according to claim 1, wherein the obtaining the compiled package comprises:
generating an address query request based on an identity number associated with the child application;
transmitting the address query request to a proxy server;
receiving a package download address from the proxy server; and
downloading the compiled package from a target server based on the package download address.

5. The method according to claim 1, further comprising:
storing the file data in a cache area of the virtual server; and
retrieving, from the file data stored in the cache area, response data for execution of the child application.

6. The method according to claim 1, wherein the running the child application comprises:
initiating a resource request including a virtual resource locator;
obtaining a child application entry file corresponding to the virtual resource locator through the virtual server when the resource request is obtained by the virtual server;
obtaining, from the file data, response data for execution of the child application; and
running the child application corresponding to the child application identifier in the first parent application based on the child application entry file and the response data.

7. The method according to claim 1, further comprising:
initiating, via the first parent application, a resource request including a virtual resource locator;
obtaining, via the virtual server, an entry file corresponding to the virtual resource locator; and
executing the child application based on the entry file and associated resource data.

8. The method according to claim 6, wherein the obtaining, from the file data, the response data comprises:
initiating, through an embedded page frame instance, a file obtaining request based on a file path included in the child application entry file; and
obtaining, from the file data through the file obtaining request, the response data.

9. The method according to claim 7, further comprising:
initiating a file obtaining request based on a file path in the entry file; and
retrieving the associated resource data based on the file path.

10. The method according to claim 1, further comprising:
obtaining a service identity bill of a target associated with the service page;
exchanging the service identity bill for a target identity bill in a second parent application; and
verifying the target identity bill via a proxy server prior to authorizing access to the target server.

11. The method according to claim 10, further comprising:
determining validity of the target identity bill based on a validity period bill; and
generating and transmitting a target interface invoking request when the target identity bill is valid.

12. The method according to claim 1, further comprising:
obtaining a target identity bill in response to a target interface invoking operation triggered in the child application run in the first parent application, the target identity bill being an identity bill of a target object in a second parent application;
generating a target interface invoking request including the target identity bill;
verifying the target identity bill through a proxy server; and
forwarding the target interface invoking request to the target server when the target identity bill is verified.

13. The method according to claim 1, further comprising:
obtaining a target identity bill in response to a login operation triggered in the child application run in the first parent application, the target identity bill being an identity bill of a target object in a second parent application;
generating a parent application interface invoking request including the target identity bill;
verifying the target identity bill through a proxy server; and
transmitting the parent application interface invoking request to the target server through the proxy server when the target identity bill is verified, the parent application interface invoking request causing a target server to log in to the child application based on a target account of the target object in the second parent application.

14. The method according to claim 12, wherein the obtaining the target identity bill comprises:
obtaining a service identity bill of the target object on the service page; and
obtaining the target identity bill of the target object in the second parent application based on the service identity bill through the virtual server.

15. The method according to claim 13, further comprising:
obtaining a validity period bill corresponding to the target identity bill, wherein
the generating the parent application interface invoking request includes generating the parent application interface invoking request when the target identity bill is determined to be valid based on the validity period bill.

16. A data processing apparatus, comprising:
processing circuitry configured to:
display, via a first parent application, a service page including a child application identifier of a child application;
initiate, in response to a user operation on the child application identifier, a request to run the child application;
in response to the request:
obtain, via a virtual server, a compiled package corresponding to the child application identifier; and
parse the compiled package to obtain file data associated with the child application; and
run the child application in the first parent application based on the file data.

17. The apparatus according to claim 16, wherein the processing circuitry is further configured to:
generate an address query request based on an identity number associated with the child application;
transmit the address query request to a proxy server;
receive a package download address from the proxy server; and
download the compiled package from a target server based on the package download address.

18. The apparatus according to claim 16, wherein the processing circuitry is further configured to:
store the file data in a cache area of the virtual server; and
retrieve, from the file data stored in the cache area, response data for execution of the child application.

19. The apparatus according to claim 16, wherein the processing circuitry is further configured to:
obtain a service identity bill of a user associated with the service page;
exchange the service identity bill for a target identity bill in a second parent application; and
verify the target identity bill via a proxy server prior to authorizing access to the target server.

20. A non-transitory computer-readable storage medium storing instructions which when executed by at least one processor cause the at least one processor to:
display, via a parent application, a service page including a child application identifier;
initiate, in response to a user operation on the child application identifier, a request to run the child application;
in response to the request:
obtain, via a virtual server, a compiled package corresponding to the child application identifier; and
parse the compiled package to obtain file data associated with the child application; and
run the child application in the parent application based on the file data.
